(19) United States
(12) Patent Application Publication
(10) Pub. No.: US 2007/0133065 A1
(43) Pub. Date: Jun. 14, 2007

(54) Image forming apparatus, image processing apparatus and image forming system

(75) Inventors: Tokiyuki Okano, Yamatokoriyama-shi (JP); Kohsuke Harada, Nara-shi (JP); Makoto Higuchi, Yamatokoriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/604,801

(22) Filed: Nov. 28, 2006

(30) Foreign Application Priority Data
Dec. 12, 2005 (JP) 2005-357675

(51) Int. Cl. H04N 1/00

(52) U.S. Cl. 358/441

(57) ABSTRACT

An image forming apparatus comprising an image processor which has output means for generating data for image formation based on image data and outputting the generated data for image formation and an image forming unit for forming an image based on the data for image formation generated by the image processor, wherein the image forming unit comprises storage means for storing information about an image forming speed and means for outputting the stored information, and the image processor comprises obtaining means for obtaining the information stored in the storage means and adjusting means for adjusting an output speed of the data for image formation based on the information obtained by the obtaining means.

### CROSS-REFERENCE TO RELATED APPLICATIONS

This Nonprovisional application claims priority under 35 U.S.C. §119(a) on Patent Application No. 2005-357675 filed in Japan on Dec. 12, 2005, the entire contents of which are hereby incorporated by reference.

### BACKGROUND OF THE INVENTION

1. Field of the Invention

The present invention relates to: an image forming apparatus which comprises an image processor for generating data for image formation based on image data and an image forming unit for forming an image based on the data for image formation generated by the image processor; an image processing apparatus which constitutes the image forming apparatus; and an image forming system which comprises the image processing apparatus.

2. Description of Related Art

In recent years, with the speeding up of or the increase in the information amount of information processing typified by the Internet, an image forming apparatus, such as a printer or a digital complex machine comprising a scanning function, a printing function, a facsimile function and the like, has been used in more business situations, and is utilized by many users ranging from a small office to a large company.

In the meantime, with the diversification of requests from users for an image forming apparatus, an image forming apparatus has a wider variety of functions and requested are more product lineups. Various image forming apparatuses which are requested include, for example, a small device which has a low print speed or copying speed but can be obtained at a relatively low price, a large device which is expensive but can execute high-speed processing and incorporates many functions such as a communication network function, a medium-sized device positioned halfway therebetween, a model for color image formation, a model only for monochrome image formation, and the like.

Such an image forming apparatus is composed of a plurality of units such as a scanning unit for reading an original copy, an image processor for processing image data obtained by the scanning unit and a printing unit for printing an image on recording paper, and a combination of units having the most suitable specifications is selected from a number of specifications, according to the model of the image forming apparatus. Since each unit respectively stores a program or data necessary for controlling the operation, management thereof is troublesome.

Therefore, an image forming apparatus which has been proposed comprises a storage device for batch storage of a program or data for controlling other units that is provided inside the body of an image forming apparatus or a central device, so as to transfer the stored program or data to a rewritable storage device that is provided inside another unit at the time of initialization in order to simplify management of a program or data in storage devices between a plurality of units and prevent a trouble such as malfunction from being caused by a partial change of units (see Japanese Patent Application Laid-Open No. H5-297654 (1993), for example).

In an image forming apparatus of the patent mentioned above wherein batch management of a program or data for controlling other units can be performed in the body of an image forming apparatus, however, it is necessary to prepare a number of units having different specifications to get many product lineups of image forming apparatuses, and reduction of the number of components and cost reduction by standardization of components are required.

### BRIEF SUMMARY OF THE INVENTION

The present invention has been made with the aim of solving the above problems, and it is an object thereof to provide: an image forming apparatus which comprises obtaining means for obtaining information about an image forming speed stored in an image forming unit and adjusting means for adjusting an output speed of data for image formation to be outputted to the image forming unit based on the obtained information, so as to use a common image processor even for different image forming units and reduce the cost; an image processing apparatus which constitutes the image forming apparatus; and an image forming system which comprises the image processing apparatus.

Another object of the present invention is to provide: an image forming apparatus wherein the image processor comprises obtaining means for obtaining information about an image reading speed stored in an image reading unit and adjusting means for adjusting an accepting speed of image data to be accepted from the image reading unit based on the obtained information, so as to use a common image processor even for different image reading units and reduce the cost; an image processing apparatus which constitutes the image forming apparatus; and an image forming system which comprises the image processing apparatus.

Another object of the present invention is to provide an image forming apparatus wherein the image processor obtains information stored in the image forming unit or the image reading unit when a first power-on operation is accepted, so as to realize a process according to a combined image forming unit or image reading unit even when an image forming unit or an image reading unit having a different specification, function or the like is combined.

Another object of the present invention is to provide an image forming apparatus wherein the image processor obtains information stored in the image forming unit or the image reading unit every time a power-on operation is accepted, so as to realize a process according to a combined image forming unit or image reading unit even when an image processor is exchanged.

Another object of the present invention is to provide an image forming apparatus wherein the image processor comprises means for giving warning when the obtained information is not predetermined information, so as to prevent combining an image processor with an image forming unit or an image reading unit by mistake.

Another object of the present invention is to provide an image forming apparatus wherein the image processor adjusts an output speed of the data for image formation or an accepting speed of the image data based on a prestored initial value when the information is not obtained, so as to activate the apparatus in a required initial state.

An image forming apparatus according to the present invention is an image forming apparatus comprising an image processor which has output means for generating data for image formation based on image data and outputting the generated data for image formation and an image forming unit for forming an image based on the data for image formation generated by the image processor, characterized in that the image forming unit comprises storage means for storing information about an image forming speed and means for outputting the stored information, and the image processor comprises obtaining means for obtaining the information stored in the storage means and adjusting means for adjusting an output speed of the data for image formation based on the information obtained by the obtaining means.

An image forming apparatus according to the present invention is characterized by comprising an image reading unit for reading an image on a sheet and generating image data, wherein the image reading unit comprises storage means for storing information about an image reading speed and means for outputting the stored information, and the image processor comprises obtaining means for obtaining the information stored in the storage means, accepting means for accepting the image data from the image reading unit and adjusting means for adjusting an accepting speed of the image data based on the information obtained by the obtaining means.

An image forming apparatus according to the present invention is characterized in that the image processor comprises means for accepting an operation for power-on and determining means for determining whether an operation accepted by said means is first power-on or not, and the obtaining means is constructed to obtain information stored in the image forming unit or the image reading unit when the determining means determines that the accepted operation is first power-on.

An image forming apparatus according to the present invention is characterized in that the image processor comprises means for accepting an operation for power-on and the obtaining means is constructed to obtain information stored in the image forming unit or the image reading unit every time an operation for power-on is accepted.

An image forming apparatus according to the present invention is characterized in that the image processor comprises determining means for determining whether the obtained information is predetermined information or not and means for giving warning when it is determined that the obtained information is not predetermined information.

An image forming apparatus according to the present invention is characterized in that the image processor comprises storage means for storing an initial value for adjusting an output speed or an accepting speed, and the adjusting means is constructed to adjust an output speed of the data for image formation or an accepting speed of the image data based on the stored initial value when information stored in the image forming unit or the image reading unit is not obtained.

An image processing apparatus according to the present invention is an image processing apparatus comprising accepting means for accepting image data and output means for generating data for image formation based on the image data accepted by the accepting means and outputting the generated data for image formation, characterized by comprising obtaining means for obtaining information about an image reading speed or an image forming speed and adjusting means for adjusting an accepting speed of the image data or an output speed of the data for image formation based on the information obtained by the obtaining means.

An image forming system according to the present invention is an image forming system comprising: an image reading apparatus for reading an image on a sheet and generating image data; an image processing apparatus which has accepting means for accepting the image data generated by the image reading apparatus and output means for generating data for image formation based on the image data accepted by the accepting means and outputting the generated data for image formation; and an image forming apparatus for forming an image based on the data for image formation generated by the image processing apparatus, characterized in that the image reading apparatus comprises storage means for storing information about an image reading speed and means for outputting the stored information, the image forming apparatus comprises storage means for storing information about an image forming speed and means for outputting the stored information, and the image processing apparatus comprises obtaining means for obtaining information stored in the image reading apparatus or information stored in the image forming apparatus and adjusting means for adjusting an accepting speed of the image data or an output speed of the data for image formation based on the information obtained by the obtaining means.

With the present invention, the image processor obtains information about an image forming speed stored in the image forming unit. When the generated data for image formation is outputted to the image forming unit, the image processor adjusts an output speed of the data for image formation based on the obtained information. Accordingly, even when an image forming unit having a different image forming speed is combined with the image processor, data for image formation can be outputted according to the combined image forming unit and a common image processor can be used.

With the present invention, the image processor obtains information about an image reading speed stored in the image reading unit. When the image data is accepted from the image reading unit, the image processor adjusts an accepting speed of the image data based on the obtained information. Accordingly, even when an image reading unit having a different image reading speed is combined with the image processor, image data can be accepted according to the combined image reading unit and a common image processor can be used.

With the present invention, the image processor determines whether an accepted operation for power-on is the first power-on or not. When it is determined that the accepted operation is the first power-on, the image processor obtains information stored in the image forming unit or the image reading unit.

With the present invention, the image processor obtains information stored in the image forming unit or the image reading unit every time an operation for power-on is accepted.

With the present invention, the image processor gives warning when it is determined that the obtained information is not predetermined information.

With the present invention, the image processor prestores an initial value for adjusting an output speed or an accepting speed. The image processor adjusts an output speed of the data for image formation or an accepting speed of the image data based on the prestored initial value when information stored in the image forming unit or the image reading unit is not obtained. For example, when a prestored initial value is one for adjusting an output speed or an accepting speed to a low speed, activation at a high speed is prevented and the power consumption can be lowered.

With the present invention, the image processing apparatus obtains information about an image reading speed or an image forming speed. The image processing apparatus adjusts an accepting speed of the image data or an output speed of the data for image formation based on the obtained information.

With the present invention, the image processing apparatus obtains information about an image reading speed stored in the image reading apparatus. The image processing apparatus also obtains information about an image forming speed stored in the image forming apparatus. The image processing apparatus adjusts an accepting speed of the image data based on the obtained information when the image data is accepted from the image reading apparatus. The image processing apparatus also adjusts an output speed of the data for image formation based on the obtained information when the generated data for image formation is outputted to the image forming apparatus. Accordingly, even when a plurality of image reading apparatuses having different image reading speeds or a plurality of image forming apparatuses having different image forming speeds are provided, acceptance of image data or output of data for image formation can be performed according to the provided image reading apparatuses or image forming apparatuses, and a common image processing apparatus can be used.

With the present invention, the image processor comprises obtaining means for obtaining information about an image forming speed stored in the image forming unit and adjusting means for adjusting an output speed of the data for image formation to be outputted to the image forming unit based on the obtained information, so as to use a common image processor even for different image forming units and reduce the cost.

With the present invention, the image processor comprises obtaining means for obtaining information about an image reading speed stored in an image reading unit and adjusting means for adjusting an accepting speed of image data to be accepted from the image reading unit based on the obtained information, so as to use a common image processor even for different image reading units and reduce the cost.

With the present invention, the image processor obtains information stored in the image forming unit or the image reading unit when a first power-on operation is accepted, so as to realize a process according to a combined image forming unit or image reading unit even when an image forming unit or an image reading unit having a different specification or function is combined.

With the present invention, the image processor obtains information stored in the image forming unit or the image reading unit every time a power-on operation is accepted, so as to realize a process according to a combined image forming unit or image reading unit even when an image processor is exchanged.

With the present invention, the image processor comprises means for giving warning when the obtained information is not predetermined information, so as to prevent combining an image processor with an image forming unit or an image reading unit by mistake.

With the present invention, the image processor adjusts an output speed of the data for image formation or an accepting speed of the image data based on a prestored initial value when the information is not obtained, so as to activate the apparatus in a required initial state. Especially, when a prestored initial value is one for adjusting an output speed or an accepting speed to a low speed, activation at a high speed is prevented and the power consumption can be lowered.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing the internal structure of a digital complex machine as an example of an image forming apparatus according to the present invention;

FIG. 2 is a block diagram showing the structure of an image processor;

FIG. 3 is an explanatory view showing the structure of image reading unit model information;

FIG. 4 is an explanatory view showing the structure of image forming unit model information;

FIG. 5 is a flow chart showing the process procedure of an image processor;

FIG. 6 is a flow chart showing the process procedure of an image processor; and

FIG. 7 is a schematic view showing the structure of an image forming system according to the present invention.

### DETAILED DESCRIPTION OF THE INVENTION

### Embodiment 1

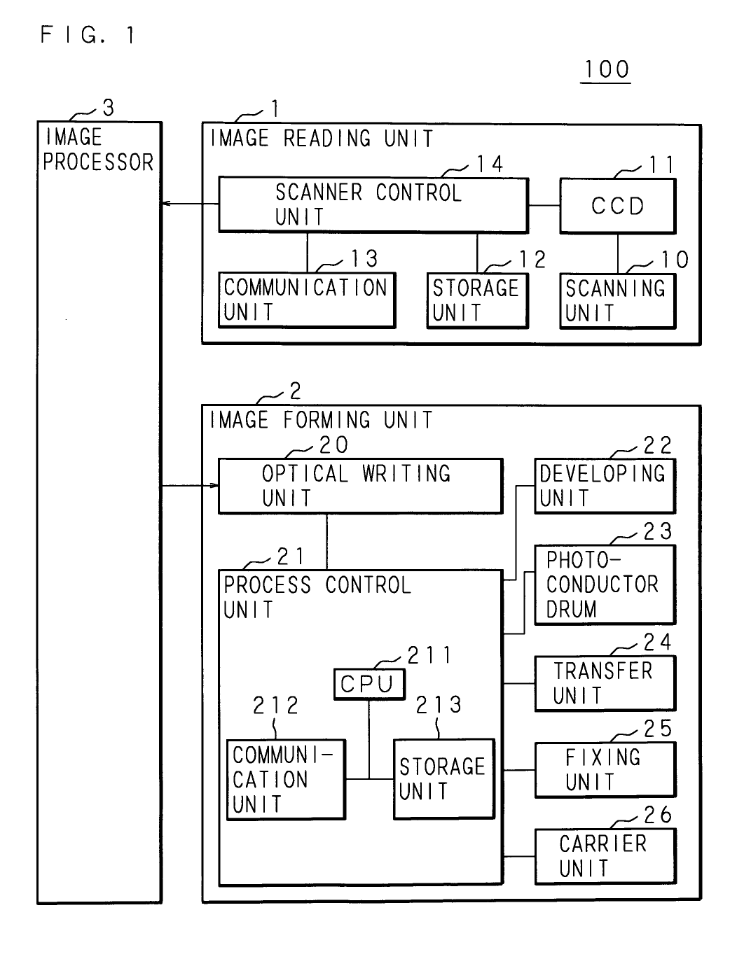

The following description will explain the present invention with reference to the drawings illustrating some embodiments thereof. FIG. 1 is a block diagram showing the internal structure of a digital complex machine as an example of an image forming apparatus 100 according to the present invention. The image forming apparatus 100 comprises an image reading unit 1 for reading an original copy to generate image data, an image processor 3 for processing the generated image data to generate data for image formation, an image forming unit 2 for performing image formation such as printing or copying based on the data for image formation and the like, which are constructed to send and receive data via an internal data bus respectively. The image processor 3 is constituted of, for example, a mounting board on which predetermined electronic components are mounted and is constructed to be connected with the image reading unit 1, the image forming unit 2 and the like in the image forming apparatus 100 via a connector (not illustrated) or the like.

The image reading unit 1 is located above a mounting table on which an original copy is mounted and comprises a scanning unit 10, a CCD 11, a storage unit 12, a communication unit 13, a scanner control unit 14, an original copy carrying unit (not illustrated) and the like. The scanning unit 10 comprises light source (not illustrated) for irradiating laser to an original copy mounted on the mounting table or an original copy carried along a paper path, a mirror (not illustrated) for guiding reflected light which has been reflected at the original copy to a predetermined optical path and the like, and provides an image at a predetermined position on the CCD 11 with laser guided from the scanning unit 10 via an imaging lens (not illustrated).

The CCD 11 outputs an electric signal, which is obtained by photoelectric conversion for a provided optical image, to the scanner control unit 14. The scanner control unit 14 generates image data, on which color separation to color components of, for example, R (red), G (green) and B (blue) are performed, based on the inputted electric signal and outputs the generated image data to the image processor 3. The scanner control unit 14 controls the operation of the image reading unit 1.

The storage unit 12 stores model information indicative of a difference in a function, a specification or the like of the image reading unit 1. The model information is, for example, information such as: a model number for identifying the image reading unit 1; information indicating that the model is one for color image formation or for monochrome image formation; or a reading speed (for example, 35 pages/minute, 40 pages/minute, 50 pages/minute, . . . ) of an original copy. For example, when the function or the specification of the image reading unit 1 is one for color image formation and the reading speed is 50 pages/minute, the storage unit 12 prestores (at the time of manufacturing of the image reading unit 1, for example) information such as: information indicating that the model is one for color image formation; a reading speed of 50 pages/minute; and the model number.

The communication unit 13 comprises a communication interface function for transferring the model information stored in the storage unit 12 to the image processor 3. The scanner control unit 14 reads out the model information from the storage unit 12 in response to a request signal from the image processor 3 and transfers the read-out model information to the image processor 3 via the communication unit 13.

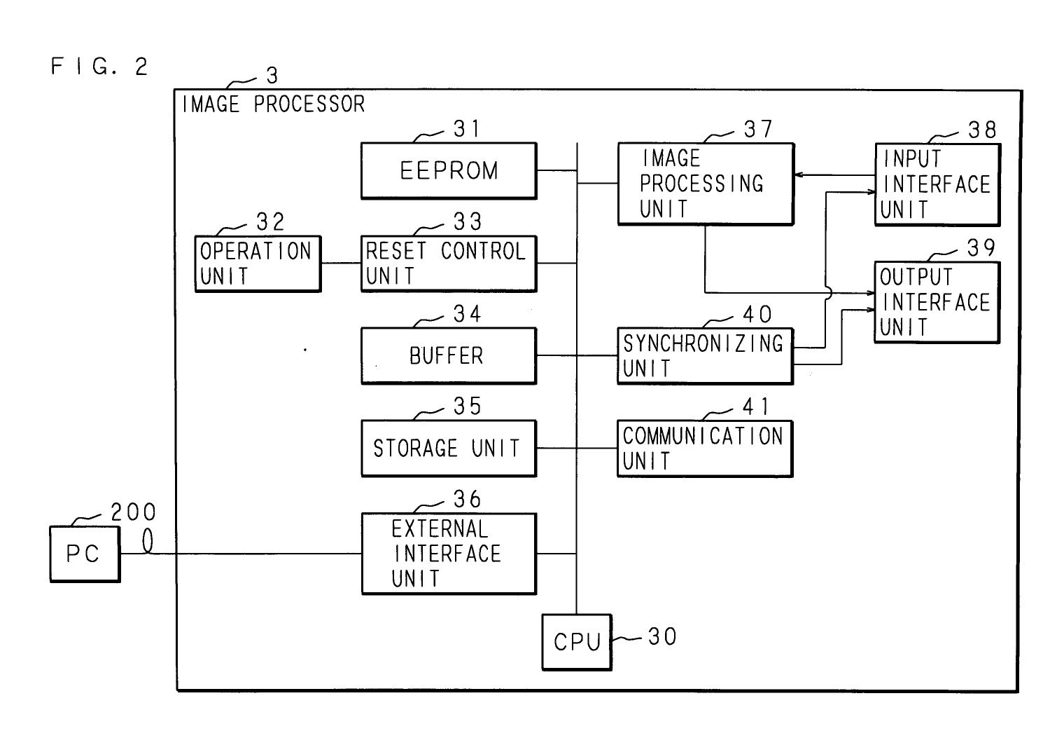

FIG. 2 is a block diagram showing the structure of the image processor 3. The image processor 3 comprises a CPU 30, an EEPROM 31, an operation unit 32, a reset control unit 33, a buffer 34, a storage unit 35, an external interface unit 36, an image processing unit 37, an input interface unit 38, an output interface unit 39, a synchronizing unit 40, a communication unit 41 and the like.

The CPU 30 controls not only the operation of the entire image processor 3 but also the operation of the entire image forming apparatus 100. That is, the CPU 30 loads a control program showing its own control procedure stored in a ROM (not illustrated) into a RAM (not illustrated), so as to control the operation of the image processor 3 and the image forming apparatus 100 according to the control procedure shown by the control program.

The EEPROM 31 prestores an initial value for initializing the operation of the image processor 3 and a flag showing the initial value. The initial value is updated when the EEPROM 31 stores model information which is obtained from the image reading unit 1 and model information which is obtained from the image forming unit 2, under the control of the CPU 30. A required value can be set as the initial value such as an input speed (transfer speed of image data) for inputting image data from the image reading unit 1 and an output speed (transfer speed of data for image formation) for outputting data for image formation generated by the image processor 3 to the image forming unit 2. As an example, an input speed (for example, 35 pages/minute) corresponding to the lowest speed value of the reading speed of the image reading unit 1, an output speed (for example, 35 pages/minute) corresponding to the lowest speed value of the image forming speed (print speed) of the image forming unit 2 or the like can be selected. Accordingly, when the image forming apparatus 100 is activated first, a processing speed can be lowered and power consumption can be lowered by preventing unnecessary high-speed processing.

The operation unit 32 is an operator control panel of a touch panel type and comprises: various kinds of keys and switches for accepting an operation instruction (for example, power on, process termination and the like) by the user, a service personnel or the like; and a liquid crystal display for displaying information to be annunciated to the user.

When an operation for power-on is performed at the operation unit 32 at the time of activation of the image forming apparatus 100 or the like, the reset control unit 33 reads out setting data such as an initial value or model information stored in the EEPROM 31 and temporarily stores the read-out setting data in the buffer 34. The reset control unit 33 cancels the reset of the CPU 30. Accordingly, the CPU 30 generates a predetermined clock signal and starts the control operation of the respective units. The CPU 30 reads out a control program from a ROM (not illustrated) and, at the same time, reads out setting data from the buffer 34 and decides a CPU activation mode based on the read-out setting data. The CPU activation mode is decided based on the setting data stored in the EEPROM 31 and a plurality of gradual processing speeds (for example, approximately 5-10 pages per minute) are set ranging from a low-speed mode (for example, an input speed and an output speed of 35 pages/minute) to a high-speed mode (for example, an input speed and an output speed of 80 pages/minute).

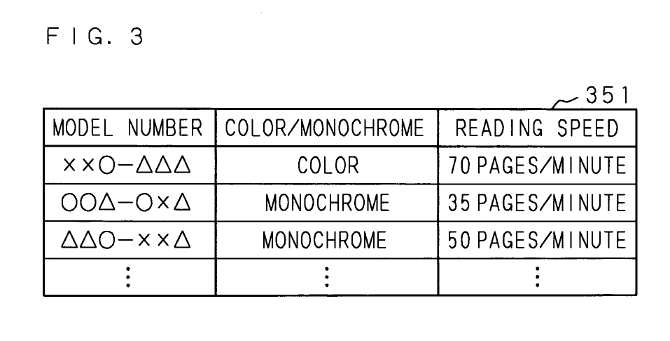

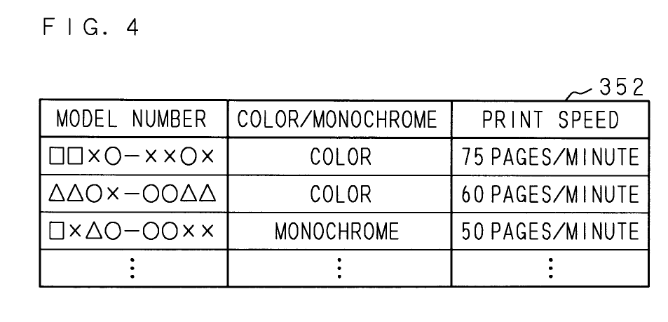

The storage unit 35 stores image reading unit model information 351 (see FIG. 3), image forming unit model information 352 (see FIG. 4) and the like indicative of which image reading unit 1 and which image forming unit 2 can be combined for use, using the image processor 3 as a common component. It should be noted that the model information stored in the storage unit 35 is not only stored at the time of manufacturing of the image processor 3 but also updated during maintenance work by a service personnel even after the image forming apparatus 100 is located.

FIG. 3 is an explanatory view showing the structure of the image reading unit model information 351. As shown in the figure, the image reading unit model information 351 is constituted of information such as: a model number; information indicating that the model is one for color image formation or for monochrome image formation; and a reading speed, and includes information corresponding to a plurality of image reading units 1. The image processor 3 can be used in common for various kinds of image reading units 1 shown in the image reading unit model information 351.

FIG. 4 is an explanatory view showing the structure of the image forming unit model information 352. As shown in the figure, the image forming unit model information 352 is constituted of information such as: a model number; information indicating that the model is one for color image formation or for monochrome image formation; and a print speed, and includes information corresponding to a plurality of image forming units 2. The image processor 3 can be used in common for various kinds of image forming units 2 shown in the image forming unit model information 352.

The communication unit 41 comprises a communication interface function for obtaining model information stored in the image reading unit 1 and the image forming unit 2 by the image processor 3.

When an operation for power-on is performed, the CPU 30 obtains model information of the image reading unit 1 and the image forming unit 2 via the communication unit 41, and determines whether the obtained model information is consistent with model information stored in the storage unit 35 or not. When the obtained model information is consistent with the stored model information, the CPU 30 determines that a normal image reading unit 1 and a normal image forming unit 2 are connected and stores the obtained model information in the EEPROM 31. Accordingly, the CPU 30 is activated in an activation model corresponding to model information stored in the EEPROM 31 when an operation for power-on is performed next time.

The CPU 30 outputs a control signal, which is for setting an input speed and an output speed corresponding to the model information stored in the EEPROM 31, to the synchronizing unit 40. For example, when the reading speed of the image reading unit 1 is 50 pages/minute, the input speed for inputting image data from the image reading unit 1 is decided to correspond to (be synchronized with) the reading speed.

The synchronizing unit 40 generates a clock signal (synchronous signal), which has a frequency corresponding to the input speed and the output speed that are divided into a plurality of steps ranging from a low speed to a high speed, based on a control signal outputted from the CPU 30, and outputs the generated clock signal to the input interface unit 38 and the output interface unit 39.

The input interface unit 38 obtains image data from the image reading unit 1 in synchronization with the clock signal outputted from the synchronizing unit 40 and outputs the obtained image data to the image processing unit 37. Accordingly, when the reading speed of the image reading unit 1 is 50 pages/minute, for example, the image data generated by the image reading unit 1 is transferred to the image processor 3 in synchronization with said reading speed.

The output interface unit 39 outputs data for image formation to the image forming unit 2 in synchronization with the clock signal outputted from the synchronizing unit 40. Accordingly, when the print speed of the image forming unit 2 is 50 pages/minute, for example, the data for image formation generated by the image processing unit 37 is transferred to the image forming unit 2 in synchronization with said print speed.

The external interface unit 36 has a communication function for sending and receiving image data to and from an external personal computer (which will be hereinafter referred to as a PC) 200. The CPU 30 receives image data made by the PC 200 via the external interface unit 36 and outputs the received image data to the image processing unit 37.

The image processing unit 37 performs a density changing process, a tone correcting process, a filtering process or the like, which is required, for image data obtained via the input interface unit 38 or the external interface unit 36, generates data for image formation to be used for printing and outputs the generated data for image formation to the image forming unit 2 via the output interface unit 39. The image processing unit 37 also has various kinds of parameters for color image processing or monochrome image processing and is constructed to be switched to color processing or monochrome processing under the control of the CPU 30.

The image forming unit 2 comprises an optical writing unit 20, a process control unit 21, a developing unit 22, a photoconductor drum 23, a transfer unit 24, a fixing unit 25, a carrier unit 26 and the like. The process control unit 21 controls the operation of the entire image forming unit 2 and comprises a CPU 211, a communication unit 212, a storage unit 213 and the like.

The optical writing unit 20 comprises: a semiconductor laser element for emitting dot light modulated corresponding to data for image formation outputted from the image processor 3; a polygon mirror for deflecting laser emitted from the semiconductor laser element to a main scanning direction; a lens and a mirror (both are not illustrated) for providing an image on the surface of the photoconductor drum 23 with laser deflected by the polygon mirror; and the like.

An electrostatic latent image is formed on the surface of the photoconductor drum 23 by a photoconductive process caused by irradiation of laser from the optical writing unit 20.

The developing unit 22 supplies the surface of the photoconductor drum 23, which has an electrostatic latent image formed thereon, with toner so as to make the electrostatic latent image visible as a developer image.

The transfer unit 24 is located near a contact position where recording paper contacts with the photoconductor drum 23, and applies transferring bias for transferring the developer image (toner image) to recording paper.

The fixing unit 25 comprises a fixing roller and applies hot processing to recording paper, which has a toner image transferred thereto, with the fixing roller so as to fix toner on the recording paper.

The carrier unit 26 carries recording paper held in a paper feeding cassette (not illustrated) through the respective processing units along a paper path (not illustrated) at a predetermined speed and ejects recording paper having an image printed thereon.

The storage unit 213 stores model information indicative of a difference in functions, specifications or the like of image forming units 2. The model information is, for example, information such as: a model number for identifying an image forming unit 2; information indicating that the model is one for color image formation or for monochrome image formation; and a print speed (for example, 35 pages/minute, 40 pages/minute, 50 pages/minute, . . . ). For example when the function or specification of the image forming unit 2 is one for color image formation and the print speed is 50 pages/minute, the storage unit 213 prestores information such as: information indicating that the model is one for color image formation; a print speed of 50 pages/minute; and a model number (at the time of manufacturing of the image forming unit 2, for example).

The communication unit 212 comprises a communication interface function for transferring model information stored in the storage unit 213 to the image processor 3. The process control unit 21 reads out model information from the storage unit 213 in response to a request signal from the image processor 3 and transfers the read-out model information to the image processor 3 via the communication unit 212.

The CPU 211 controls not only the operation of the entire process control unit 21 but also the operation of the entire image forming unit 2.

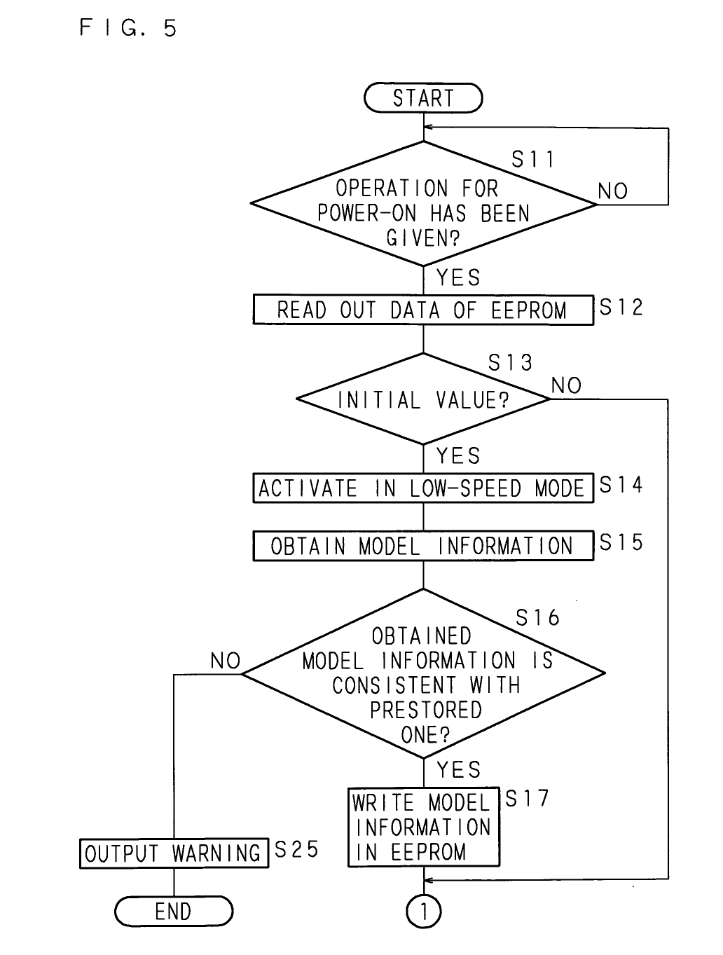

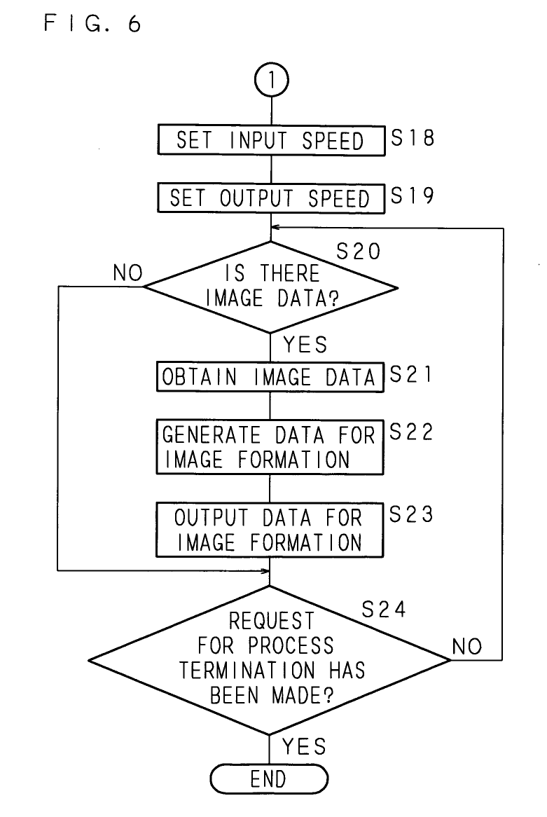

The following description will explain the operation of the image forming apparatus 100 according to the present invention. FIGS. 5 and 6 are a flow chart showing the process procedure of the image processor 3. The CPU 30 determines whether an operation for power-on has been given or not (S11), and continues the process of the step S11 and waits for an operation for power-on when an operation for power-on has not been given (NO in S11).

When an operation for power-on has been given (YES in S11), the CPU 30 reads out data of the EEPROM 31 (S12) and determines whether the read-out data is an initial value or not (S13). When the data of the EEPROM 31 is an initial value (YES in S13), the CPU 30 is activated in a low-speed mode (S14) and obtains model information from the image reading unit 1 and the image forming unit 2 (S15).

The CPU 30 determines whether the obtained model information is consistent with prestored one or not (S16). When the obtained model information is consistent with prestored one (YES in S16), the CPU 30 writes the model information in the EEPROM 31 (S17). Accordingly, an initial value stored in the EEPROM 31 is updated with model information stored in the image reading unit 1 and the image forming unit 2 which are connected with the image processor 3.

The CPU 30 sets an input speed (S18) and sets an output speed (S19) based on the obtained model information. Accordingly, input processing and output processing at the image processor 3 are set according to the processing speed of the image reading unit 1 and the image forming unit 2 which are connected.

The CPU 30 determines whether there is image data or not (S20), and obtains image data (S21) and executes a predetermined process for the obtained image data to generate data for image formation (S22) when there is image data (YES in S20). The CPU 30 outputs the data for image formation (S23) and determines whether a request for process termination has been made or not (S24). When a request for process termination has been made (YES in S24), the CPU 30 terminates the process.

When the data read out in the step S13 is not an initial value (NO in S13), the CPU 30 continues the process starting from the step S18. When the model information obtained in the step S16 is not consistent with prestored one (NO in S16), the CPU 30 outputs warning (S25) and terminates the process. When there is no image data in the step S20 (NO in S20), the CPU 30 continues the process starting from the step S24. When there is no process termination request in the step S24 (NO in S24), the CPU 30 continues the process starting from the step S20.

### Embodiment 2

As the image forming apparatus 100 in the above Embodiment 1 is constituted, as one apparatus, of the image reading unit 1, the image forming unit 2 and the image processor 3, the present invention is not limited to this and can be applied to a network or the like constituted of the image reading unit 1, the image forming unit 2 and the image processor 3 connected with a communication line or the like, for example.

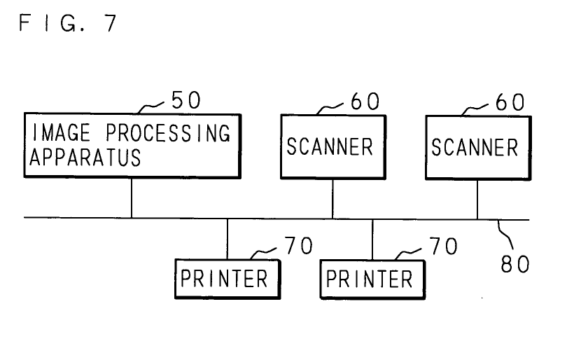

FIG. 7 is a schematic view showing the structure of an image forming system according to the present invention. In the figure, a scanner 60 corresponds to the image reading unit 1 of Embodiment 1, an image processing apparatus 50 corresponds to the image processor 3 of Embodiment 1 and a printer 70 corresponds to the image forming unit 2 of Embodiment 1. As shown in the figure, the image processing apparatus 50 is connected with a plurality of scanners 60 and 60 and a plurality of printers 70 and 70 via a communication line 80. The scanners 60 and 60 and the printers 70 and 70 are respectively of different models and have different reading speeds and different print speeds.

Since the image processing apparatus 50 has the same structure as the image processor 3 except that the image processing apparatus 50 comprises a communication interface to be connected with the communication line 80, explanation will be omitted. Moreover, since each scanner 60 has the same structure as the image reading unit 1 except that the scanner 60 comprises a communication interface to be connected with the communication line 80, explanation will be omitted. Similarly, since each printer 70 has the same structure as the image forming unit 2 except that the printer 70 comprises a communication interface to be connected with the communication line 80, explanation will be omitted.

With the structure described above, a common image processing apparatus 50 can be used for a plurality of scanners 60 and 60 and a plurality of printers 70 and 70 of different models or having different specifications, which are connected via the communication line 80, and it is unnecessary to provide a plurality of image processing apparatuses according to the models or specifications of the scanners 60 and printers 70 and the cost of the entire system can be decreased.

As explained above, with the present invention, a common image processor (or image processing apparatus) can be used for different image forming units (or printers) or different image reading units (or scanners), and the cost can be decreased. Moreover, even when an image forming unit or an image reading unit of a different model or having a different function is combined, a process can be realized corresponding to the combined image forming unit or image reading unit. Moreover, it is possible to prevent combining an image processor with an image forming unit or an image reading unit by mistake. Furthermore, when a prestored initial value is one for adjusting the output speed or the input speed to a low speed, it is possible to prevent activation at a high speed and the power consumption can be lowered.

As the above embodiment is constructed to obtain model information only when the first power-on is given (i.e., when an initial value is stored in the EEPROM), the present invention is not limited to this and may be constructed to obtain model information every time an operation for power-on is given. In this case, a process can be realized corresponding to the combined image forming unit or image reading unit even when the image processor is exchanged.

The model information in the above embodiment is only an example and the present invention is not limited to this.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image forming apparatus comprising:
an image processor for generating data for image formation based on image data and outputting the generated data for image formation; and
an image forming unit for forming an image based on the data for image formation outputted from the image processor;
wherein the image forming unit comprises a memory for storing information about an image forming speed; and
the image processor comprises a controller capable of performing operations of:
obtaining the information stored in the memory; and
adjusting an output speed of the data for image formation based on the obtained information.

2. The image forming apparatus according to claim 1, wherein
the image processor further comprises an accepting unit for accepting an operation for power-on; and
said controller is capable of performing operations of:
determining whether an operation accepted by the accepting unit is first power-on or not; and
obtaining the information stored in the memory when it is determined that the accepted operation is first power-on.

3. The image forming apparatus according to claim 1, wherein
the image processor further comprises an accepting unit for accepting an operation for power-on; and
said controller is capable of obtaining the information stored in the memory every time an operation for power-on is accepted by the accepting unit.

4. The image forming apparatus according to claim 1, wherein said controller is capable of performing operations of:
determining whether the obtained information is predetermined information or not; and
giving warning when it is determined that the obtained information is not predetermined information.

5. The image forming apparatus according to claim 1, wherein
the image processor further comprises a memory for storing an initial value for adjusting an output speed; and
said controller is capable of adjusting an output speed of the data for image formation based on the initial value stored in the memory when information stored in the image forming unit is not obtained.

6. The image forming apparatus according to claim 1, further comprising an image reading unit for reading an image on a sheet and generating image data;
wherein the image reading unit comprises a memory for storing information about an image reading speed;
the image processor further comprises an accepting unit for accepting the image data generated by the image reading unit; and
said controller is capable of performing operations of:
obtaining the information stored in the memory; and
adjusting an accepting speed of the image data based on the obtained information.

7. The image forming apparatus according to claim 6, wherein
the image processor further comprises an accepting unit for accepting an operation for power-on; and
said controller is capable of performing operations of:
determining whether an operation accepted by the accepting unit is first power-on or not; and
obtaining the information stored in the memory when it is determined that the accepted operation is first power-on.

8. The image forming apparatus according to claim 6, wherein
the image processor further comprises an accepting unit for accepting an operation for power-on; and
said controller is capable of obtaining the information stored in the memory every time an operation for power-on is accepted by the accepting unit.

9. The image forming apparatus according to claim 6, wherein said controller is capable of performing operations of:
determining whether the obtained information is predetermined information or not; and
giving warning when it is determined that the obtained information is not predetermined information.

10. The image forming apparatus according to claim 6, wherein
the image processor further comprises a memory for storing an initial value for adjusting an accepting speed; and
said controller is capable of adjusting an accepting speed of the data for image formation based on the initial value stored in the memory when information stored in the image forming unit is not obtained.

11. An image forming apparatus comprising:
an image processor for generating data for image formation based on image data and outputting the generated data for image formation; and
an image forming unit for forming an image based on the data for image formation outputted from the image processor;
wherein the image forming unit comprises storage means for storing information about an image forming speed; and
the image processor comprises:
means for obtaining the information stored in the storage means; and
means for adjusting an output speed of the data for image formation based on the obtained information.

12. The image forming apparatus according to claim 11, further comprising an image reading unit for reading an image on a sheet and generating image data;
wherein the image reading unit comprises storage means for storing information about an image reading speed; and
the image processor further comprises:
means for accepting the image data generated by the image reading unit;
means for obtaining the information stored in the storage means; and
means for adjusting an accepting speed of the image data based on the obtained information.

13. An image processing apparatus comprising:
an accepting unit for accepting image data;
an output unit for generating data for image formation based on the image data accepted by the accepting unit and outputting the generated data for image formation; and
a controller capable of performing operations of:
obtaining information about an image reading speed or an image forming speed; and
adjusting an accepting speed of the image data or an output speed of the data for image formation based on the obtained information.

14. An image processing apparatus comprising:
means for accepting image data;
means for generating data for image formation based on the accepted image data and outputting the generated data for image formation;
means for obtaining information about an image reading speed or an image forming speed; and
means for adjusting an accepting speed of the image data or an output speed of the data for image formation based on the obtained information.

15. An image forming system comprising:
an image reading apparatus for reading an image on a sheet and generating image data;
an image processing apparatus for accepting the image data generated by the image reading apparatus, generating data for image formation based on the accepted image data and outputting the generated data for image formation; and
an image forming apparatus for forming an image based on the data for image formation generated by the image processing apparatus;
wherein the image reading apparatus comprises a memory for storing information about an image reading speed;
the image forming apparatus comprises a memory for storing information about an image forming speed; and
the image processing apparatus comprises a controller capable of performing operations of:
obtaining information stored in the image reading apparatus or the image forming apparatus; and
adjusting an accepting speed of the image data or an output speed of the data for image formation based on the obtained information.

16. An image forming system comprising:
an image reading apparatus for reading an image on a sheet and generating image data;
an image processing apparatus for accepting the image data generated by the image reading apparatus, generating data for image formation based on the accepted image data and outputting the generated data for image formation; and
an image forming apparatus for forming an image based on the data for image formation generated by the image processing apparatus;
wherein the image reading apparatus comprises means for storing information about an image reading speed;
the image forming apparatus comprises a memory for storing information about an image forming speed; and
the image processing apparatus comprises:
means for obtaining information stored in the image reading apparatus or the image forming apparatus; and
means for adjusting an accepting speed of the image data or an output speed of the data for image formation based on the obtained information.
